(19) United States
(12) Patent Application Publication
(10) Pub. No.: US 2004/0101439 A1
(43) Pub. Date: May 27, 2004

(54) Biological and chemical reaction devices and methods of manufacture

(76) Inventors: Adam J. Fusco, Painted Post, NY (US); Cheng-Chung Li, Painted Post, NY (US); Po Ki Yuen, Corning, NY (US)

Correspondence Address: CORNING INCORPORATED, SP-TI-3-1, CORNING, NY, 14831

(21) Appl. No.: 10/301,277

(22) Filed: Nov. 21, 2002

(51) Int. Cl. G01N 21/00

(52) U.S. Cl. 422/57

(57) ABSTRACT

Methods and devices for performing biological and chemical reactions are disclosed. The devices and methods include a reaction chamber formed on a base substrate, a spacer, and a gripping element adapted to receive a cover substrate.

### FIELD OF THE INVENTION

This invention relates to reaction devices used for biological and chemical analysis and methods of manufacturing such devices.

### BACKGROUND OF THE INVENTION

Biological and chemical reaction devices such as high density arrays and microfluidic devices are used in molecular biology, pharmaceutical research, genomic analysis, and in other applications. High density arrays are solid surfaces containing surface bound biomolecules arrayed in specific positions and used in analysis of solutions containing a mixture of analytes. In some types of arrays, such as arrays used in hybridization experiments, the surface bound biomolecules are called probe molecules and the mixture of analytes contains what are sometimes called target molecules. Examples of such biomolecules include but are not limited to proteins, antibodies, oligonucleotides, nucleic acids, peptides and polypeptides. For example, DNA microarrays are used to identify which genes are “turned on or off” in a cell or tissue, and to evaluate the extent of a gene presence under various conditions. After hybridization with cDNA labeled with a fluorochrome or other label, the slides can be read with a fluorescence scanner or other device. When fluorescence scanning is used, the presence of a specific gene in the sample is revealed by fluorescence of the corresponding hybridized spot on the chip. Fluorescence intensity is related to the number of hybridized strands at the spot, which is related to the gene abundance in the sample.

Biological and chemical reactions such as hybridization reactions require adequate interaction between the target molecules in the fluid and the probe molecules bound to the substrate. One typical arrangement for performing hybridization reactions involves the use of an array of probe molecules immobilized on a substrate having a surface area typically less than a few square centimeters. After the fluid containing the target molecules is placed in contact with a substrate, a second glass slide or cover slip is used to cover the fluid. Hereinafter, this technique will be referred to as the cover slip technique.

The cover slip technique does not adequately control the volume of fluid across the surface area of the slide. Furthermore, fluid has a tendency to leak out from between the cover slip and the slide during use. Although it is possible to contain the fluid by sealing the edges of the cover slip and the slide with an adhesive, this approach is time consuming and can introduce contaminants into the fluid. Another approach to containing the fluids involves the use of an O-ring or gasket between the substrate and the cover slide. A limitation to this approach is that such O-rings and gaskets are typically greater than 1.5 mm thick, which provides a very large space between the cover slip and the slide. One drawback of conventional reaction chambers having a large space between the cover slide and the substrate is that they require large quantities of fluid.

Although a variety of apparatus and methods exist related to reaction chambers which are used in biological and chemical assays, there still exists a need for improved devices and methods for performing such assays.

### SUMMARY OF INVENTION

One embodiment of present invention relates to a biological or chemical reaction device. Other embodiments relate to methods of forming a biological or chemical reaction device. The devices and methods include a reaction chamber formed on a base substrate, a spacer, and a gripping element adapted to receive a cover substrate. According to certain embodiments, the ability to snap-on the cover substrate to the base substrate provides a convenient means of assembling or disassembling different components or modules via a simple assembly step.

Advantages of the invention will be apparent from the following detailed description. It is to be understood that both the foregoing general description and the following detailed description are exemplary and are intended to provide further explanation of the invention as claimed.

### BRIEF DESCRIPTION OF THE DRAWINGS

FIG. 1 is a perspective view of a biological or chemical reaction chamber device according to one embodiment of the invention;

FIG. 2 is an edge view a substrate and a layer of material used to make a biological or chemical reaction chamber device;

FIG. 3 is an edge view a substrate and a peripheral layer of material used to make a biological or chemical reaction chamber device;

FIG. 4 is a side view a substrate and a peripheral layer of material surrounded by a monomeric or polymeric material and a photomask;

FIG. 5 is an edge view of a finished biological or chemical reaction chamber device showing a substrate and a peripheral layer of material surrounded by a peripheral gripping element;

FIG. 6 is a perspective view of a stacked biological or chemical reaction chamber device according to one embodiment of the invention;

FIG. 7 is a chart comparing the results of hybridization reactions in a device according to one embodiment of the invention with the results of a prior art device;

FIG. 8 is a chart comparing the results of hybridization reactions in a device according to one embodiment of the invention with the results of a prior art device;

FIG. 9 is a chart comparing the results of hybridization reactions in a device according to one embodiment of the invention with the results of a prior art device; and

FIG. 10 is a chart comparing the results of hybridization reactions in a device according to one embodiment of the invention with the results of a prior art device;

### DETAILED DESCRIPTION

Before describing several exemplary embodiments of the invention, it is to be understood that the invention is not limited to the details of construction, process steps, reagents and biomolecules set forth in the following description. The invention is capable of other embodiments and of being practiced or being carried out in various ways.

The present invention relates to methods and devices for performing biological or chemical reactions. Certain embodiments of the present invention provide enhanced reaction or interaction between surface bound biomolecules and analytes or biomolecules contained in solution. One type of reaction in which surface bound probes and target molecules in solution interact is called hybridization reactions. As used herein, the term hybridization refers to binding between complementary or partially complementary molecules. The term probe means a molecule adhered to a substrate. The term target means a molecule in solution.

However, the present invention is not limited to hybridization reactions or any specific type of hybridization reaction, and the chambers and methods of the various embodiments of the present invention can be used in a wide variety of biological or chemical reactions. Examples of a few of the types of reactions that the present invention can be used, include, but are not limited to fluorescent in situ hybridization (FISH), protein array reactions, immunostaining applications and general staining or histochemical reactions. In FISH reactions, the analytes in solution include DNA probes (oligomers, cDNAs, PCR fragments, or clones such as plasmids), BACs (bacterial artificial chromosomes), PACs (phage artificial chromosomes), cosmids, or phage chromosomes, and the surface bound biomaterial (analyte binding partner) can include whole human chromosomes or fragments thereof, that are typically contained in human metaphase spreads, or where the affixed biomaterial is whole human cells or nuclei, or even extracted human DNA, where the DNA has been made available for hybridization to the analyte in solution. In protein arrays, the analyte in solution typically includes one or more antibodies or substrates that are labeled directly or indirectly, and the surface bound biomaterial includes one or more proteins that have affinity for one or more of the analytes in solution. In immunostaining reactions, the analyte in solution typically includes one or more antibodies that are labeled directly or indirectly, and the surface bound biomaterial includes one or more antigens of the type including DNA, RNA, protein, cell membranes, metabolites, whole cells, bacteria, fungi, viruses and the like. In other types of immunostaining reactions, the analyte in solution includes one or more antigens of the type including DNA, RNA, protein, cell membranes, metabolites, whole cells, bacteria, fungi, viruses and the like, and the surface bound biomaterial includes one or more antibodies. In general histochemical or general staining reactions, the surface bound biomaterial is any type of biomaterial and the analyte in solution includes one or more of commonly used stains, such as Eosin, Hematoxilyn, etc. Thus, it is to be understood that the devices and methods of the present invention can be used in a wide variety of biological or chemical reactions to overcome diffusion limitations imposed on the interaction between surface bound biomaterials or biomolecules and analytes contained in solution by reducing the volume of a reaction chamber, which increases the effective concentration.

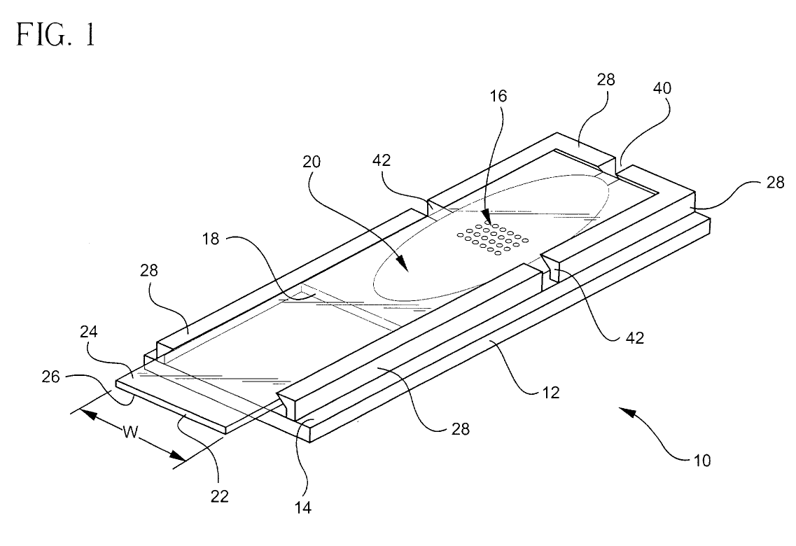

An exemplary embodiment of a reaction chamber device is shown in FIG. 1 and designated generally as 10. The device 10 includes a generally planar base substrate 12 having an inner surface 14 including a specimen area 16. The device further includes a spacer element 18 having a height on the base substrate defining a chamber 20 surrounding the specimen area and a generally planar cover substrate 22 having a width W and a length, an outer surface 24, and an inner surface 26 opposing and substantially parallel to the inner surface 14 of the base substrate 12. A flexible gripping element 28 is located on the base substrate 12. The flexible gripping element 28 defines a spaced apart area having a width 30 adapted to receive the cover substrate 22 and secure the cover substrate 22 to the base substrate 12. The substrates are typically made from glass, however, other materials such as polymers, polystyrene, fused silica, polypropylene, metal and combinations thereof can be used.

According to certain embodiments, the flexible gripping element 28 forms a boundary around the spacer element 18 defined by at least two substantially parallel, the spaced apart walls 31 including an upper portion 32 and a lower portion 34 adjacent the base substrate 12. According to certain embodiments of the invention, the spacing 30 between the substantially parallel walls is greater at the lower portion 34 adjacent the base substrate 12 than the spacing between the walls at top portion 32. In some embodiments, the spacing 30 between the parallel walls at the top portion 34 is less than the width W of the cover substrate 22. According to some embodiments, the walls 31 are adapted to receive the cover substrate 22 by snap-fitting the cover substrate 22 such that the inner surface 26 of the cover substrate 22 is in contact with the spacer element 18, and the gripping element 28 provides vertical holding force on the cover substrate. In some embodiments, the flexible gripping element 28 is defined by at least a pair of substantially parallel walls 31 including a sloped inner surface 33. Preferably, the walls 31 have a thickness that is greater at the upper portion 32 than the thickness at the lower portion 34.

According to certain embodiments of the invention, the device further includes at least one fluid inlet 40 and at least one fluid outlet 42. Additional fluid inlets 40 and outlets 42 can be provided if desired. In certain embodiments, the inlet 40 and the outlet 42 extend through the spacer element 18 and flexible gripping element 28 to allow fluid to enter and exit the chamber 20.

In certain preferred embodiments, the height of the spacer element is less than 100 microns, and in other embodiments the height of the spacer element is less than 50 microns. In some preferred embodiments, the height of the spacer element is less than 10 microns, and the height of the spacer element can be as low as 1 micron.

Certain embodiments relate to methods of forming a biological or chemical reaction device. Referring to FIGS. 1-5, according to one embodiment a method of forming a biological or chemical reaction device includes providing a generally planar base substrate 12 having an inner surface 14 including a specimen area 20. A spacer element 18 is formed on the inner surface 14 of the based substrate. The spacer element 18 has a height and provides a boundary that defines a chamber 20 surrounding the specimen area 16 on the base substrate 12.

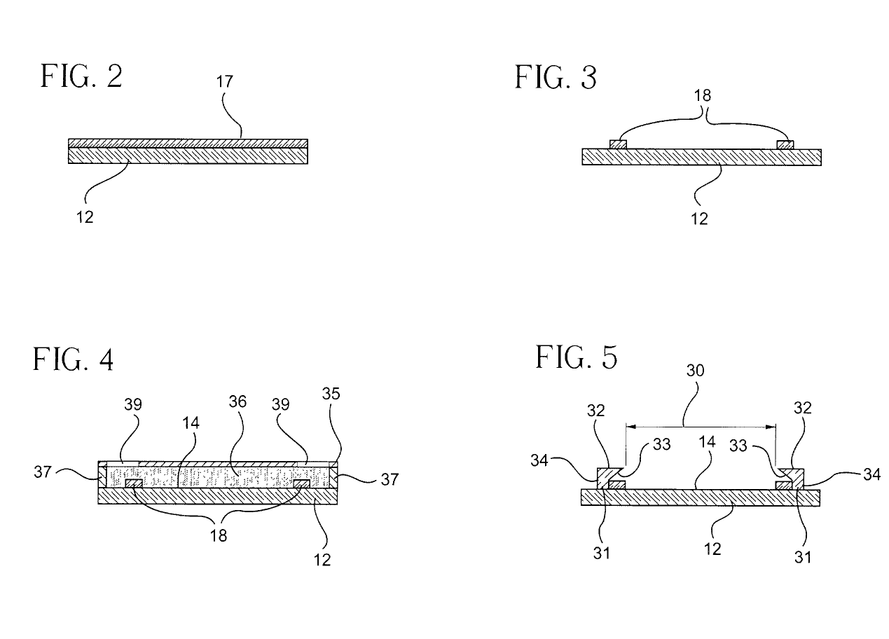

According to certain embodiments of the invention, fabrication of chambers is accomplished by utilizing conventional photolithographic techniques that are typically used in the manufacture of optical and electronic devices. For example, the spacer element 18 can be formed using spin coating techniques to deposit a layer of photoresist 17 on the substrate 12 as shown in FIG. 2. Spin-coating is known in the art of electronics manufacture. Photolithographic techniques can then be used to remove a portion of the photoresist to provide spacing elements 18 and form a reaction chamber in the photoresist layer 17. It will be understood that other photo patternable materials such as polysiloxane film can be used instead of photoresist. Formation of the spacer element 18 by spin coating allows the spacer element 18 to be formed to very precise dimensional tolerances, and spacer elements 18 having a height as small as 1 micron can be formed using spin coating techniques. The spacer elements could also be made using other processes such as photolithographic processes.

The method of forming a biological or chemical reaction chamber also includes forming a flexible gripping element 28 including at least a pair of flexible, substantially parallel, spaced apart walls 31 and snap fitting a generally planar cover substrate between the spaced apart walls. A flexible gripping element can be formed by first applying an adhesion promoter such as trichlorosilane to the inner surface 14 of the substrate 12. Then, a photo-definable polymer or monomer 36 can coated on top or inner surface of the substrate 12 and temporary spacers 37 can be placed between the substrate to define the height of the gripping elements. A photo mask 35 and ultraviolet light (not shown) can be used to selectively cure the polymer or monomer through apertures 39 defined in the photo mask and form at least a pair of substantially parallel walls 31. The substantially parallel walls having inwardly sloping surfaces 33 provide a gripping element that allows a planar cover substrate to be easily snapped on or off the base substrate 12 and enclose the chamber. In preferred embodiments, the spaced apart walls 31 are formed by photolithography, for example, by curing a monomer or polymer 33 through a mask 35 having apertures 39. The temporary spacer 37 can be used to define the overall height of the walls 31 during formation of the gripping elements.

Gripping elements or grippers are versatile structures that can be fabricated from flexible polymeric materials. Details on the construction of gripping elements are described in U.S. Pat. Nos. 6,266,472 and 5,359,687, both of which are incorporated herein by reference. In U.S. Pat. No. 5,359,687, the gripping elements, which are also called polymer microstructures, are formed on a substrate and used to grip optical fibers and position these fibers with respect to a waveguide disposed on the substrate. U.S. Pat. No. 6,266,472 describes polymer gripping elements that are used in splicing optical fibers. Applicants have discovered that flexible gripping elements can be utilized to secure cover substrates to a base substrate to form biological or chemical reaction chambers.

Gripping elements can be manufactured by depositing strips of material on the surface of the substrate. As discussed above, the strips that make up the gripping elements can be formed using well-known lithographic processes using photopolymerizable compositions and the like. For example, a photopolymerizable composition can be substantially uniformly deposited on onto a substrate surface. The photopolymerizable composition is then imagewise exposed to actinic radiation using a laser and a computer-controlled stage to expose precise areas of the composition with an ultraviolet laser beam, or a collimated UV lamp together with a photomask having a pattern of substantially transparent and substantially opaque areas. The nonimaged areas can then be removed with solvent, while leaving the imaged areas in the form of at least one gripping element on the substrate surface.

Alternatively, flexible strips can be formed by using a soft, flexible embossing tool to pattern the polymerizable composition in the form of at least one gripping element on the substrate surface. Such soft tooling is commonly made with silicones. The composition is then cured and the tool is removed. The flexibility of the tool must be sufficient so that it can be removed from the cured polymer without damaging the grippers. The polymerizable composition may be cured by various means such as actinic radiation or heat, and should have the viscosity to conform to the raised features of the tool. After removing the tool from the cured composition, at least one gripping element will remain on the substrate, depending on the nature of the pattern. Suitable polymeric compositions for making the gripping elements are disclosed in commonly assigned U.S. Pat. No. 6,266,472.

However, the invention is not limited to any particular manufacturing technique. Other techniques such as injection molding can be used to form the device. For example, the micro-replication methods can be used to mold a soft working tool out of a material such as silicone, and then a polymeric material can be injected into the tool to form the spacer element, the gripping element and the substrate. The entire device can be formed in a single or multi-step curing process using UV or thermal curing. Other materials can be used in the fabrication of the devices of the invention. For example, the flexible gripping elements could be made from elastomers, natural rubber or other suitable materials.

A wide variety of polymers can be used in the fabrication of gripping elements. Preferred for use in the fabrication of elements 14 are photopolymers formed by the photo-polymerization of a photoreactive monomer or mixtures of such monomers such as urethane acrylates and methacrylates, ester acrylates and methacrylates, epoxy acrylates and methacrylates, polyethylene glycol acrylates and methacrylates and vinyl containing organic monomers. Illustrative of such acrylate and methacrylate monomers are aryl diacrylates or methacrylates, triacrylates or methacrylates and tetra acrylates or methacrylates.

A photo mask or image mask bearing a pattern of opaque areas which allow UV light to pass through only in the areas which comprise the pattern of the flexible gripping element is positioned above monomer or polymer layer, and WV light (not shown) as for example from a mercury or xenon lamp, is directed to fall on the surface of image mask or photomask. UV light which passes through the clear areas of mask causes a photopolymerization reaction in the regions of monomer or polymer layer which are directly under those image areas. No photoreaction occurs in those areas of monomer or polymer layer which are shielded from the UV light by the opaque areas of image mask. After irradiation by UV light, image mask is removed and the unreacted monomer or polymer can washed away with a suitable solvent such as acetone or methanol, leaving a photopolymerized gripping on the base substrate. The gripping elements include a pair of spaced apart walls 31. According to certain embodiments, the walls 31 have a substantially trapezoidal cross section. The unique inverted trapezoidal geometry can be achieved by the choice of proper conditions of irradiation. The optical absorption of the unreacted monomer layer at the wavelengths of the UV light must be high enough, such that a gradient of UV light intensity is established through the film. That is, the amount of UV light available in the monomer layer to cause the initiation of the photoreaction will decrease from the top, or the image mask side, towards the bottom, or the substrate side, due to the finite absorption of the monomer layer. This gradient of UV light causes a gradient in the amount of photopolymerization reaction that occurs from top to bottom, resulting in the unique geometry of the developed polymer structure.

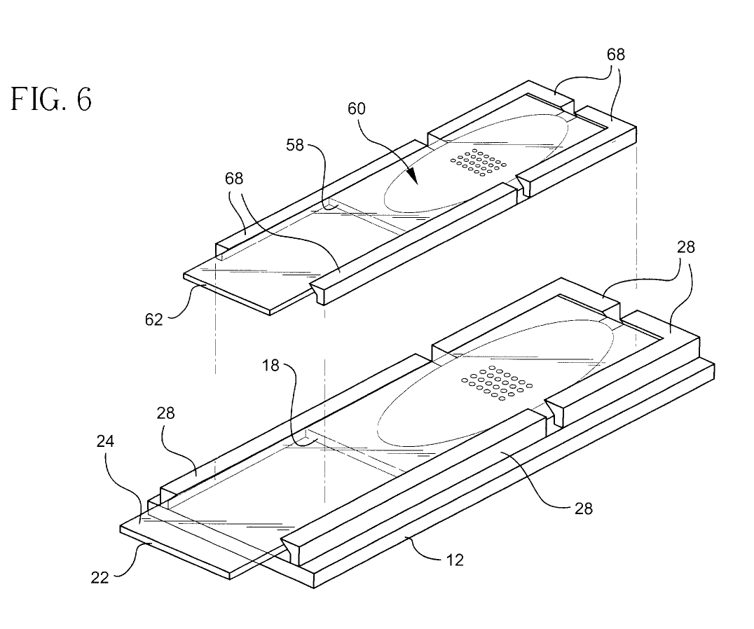

In some embodiments of the invention, stacked hybridization chambers comprised of individual chambers can be snapped together to form a three dimensional integrated device for performing two or three dimensional fluidic manipulation and biological or chemical reactions. As shown in FIG. 6, a first reaction chamber 10 including a base substrate 12, a spacer element 18 and a cover substrate 22 having an outer surface 24 further includes a second spacer element 58 on the outer surface 24 of the cover substrate 22 defining a second specimen area 60 and a second flexible gripping element 68 defining a pair of spaced apart walls adapted to receive a second cover substrate 62. Preferably, the second cover substrate 62 is adapted to snap fit between the spaced apart walls defined by the second flexible gripping elements 68. In certain embodiments, instead of or in addition to providing lateral fluid inlet and outlets on each plane of the stacked device, it may be desirable to provide at least one through-hole (not shown) in the cover substrate 22 to allow fluid to flow between the different levels of the device. Thus fluid flow could occur three dimensionally, i.e., in the same plane of each level and through at least one plane of the device. The substrates may also include microfluidic channels.

In use, the reaction chamber device can be used for biological and chemical assays. The chamber height can be as small as 1 micron to reduce the amount of hybridization solution used. The chamber is formed by snap-on structures using flexible gripping elements. The cover substrate is snapped into place between the substantially parallel walls. The spacer element defines a frame that surrounds at least a portion of the specimen area, and the frame and the substrate define a well for holding a fluid such as a hybridization solution. Fluid can be introduced through the fluid inlet 40 and fluid exits the fluid outlets 42. More specifically, hybridization solution is injected into the well through the inlet via capillary action and the hybridization chamber is left undisturbed under conditions and time sufficient to permit hybridization. The substrate can then be snapped off from the hybridization chamber and post-hybridization wash steps can be performed on the substrate. The substrate is then scanned for hybridization analysis using techniques known in the art.

Without intending to limit the invention in any manner, the invention will be more fully understood and described by the following examples, in which the conventional cover slip hybridization method was compared to hybridization devices including spacers having heights of 4 microns and fluid volumes of 15 μL.

### EXAMPLES

Hybridization and Analysis

The prehybridization and the washing steps were performed in a coplin jar in a conventional way. To study the hybridization step independently from the other part of the process (prehybridization or washing step), the hybridization chamber was used only for the hybridization step. To start the array hybridization, the chamber was placed inside a humidified box and the box was placed inside 42° C. incubator. After hybridization, the glass slides were washed, dried and scanned with the GenePix 4000A Microarray Scanner. Data were analyzed with the GenePix Pro 3.0 software (Axon Instruments, Inc., Foster City, Calif.).

Microarray hybridization assays were performed overnight at 42° C. using pre-fabricated Corning 4K Cancer arrays available from Corning, Inc and conventional hybridization processes. One group of assays was performed utilizing the embodiment shown in FIG. 1 having a spacer element height of four microns. A second groups of assays was performed with the conventional cover slip approach method on a slide area 24 mm×50 mm. The assays performed with a device similar to the one shown in FIG. 1 utilized 2 μg of total RNA, labeled with Cy3 and Cy5 fluorescent dyes, in 15 μL of hybridization solution. The two assays performed with the conventional cover slip approach were performed with either 2 μg or 6.67 μg of total RNA, labeled with Cy3 and Cy5 fluorescent dyes, in 50 μL of hybridization solution. In other words, the conventional cover slip approach either contained the same total amount of total RNA or had the same concentration but more than 3 times the amount of total RNA used compared to the present invention tested. A hybridization mixture or assay solution was prepared using conventional protocols and containing fluorescently labeled targets.

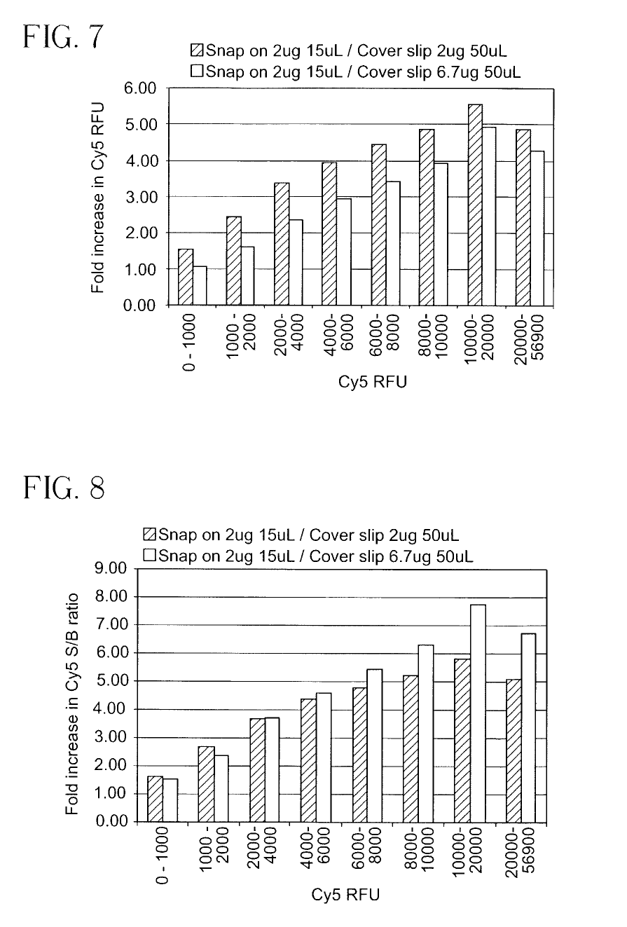

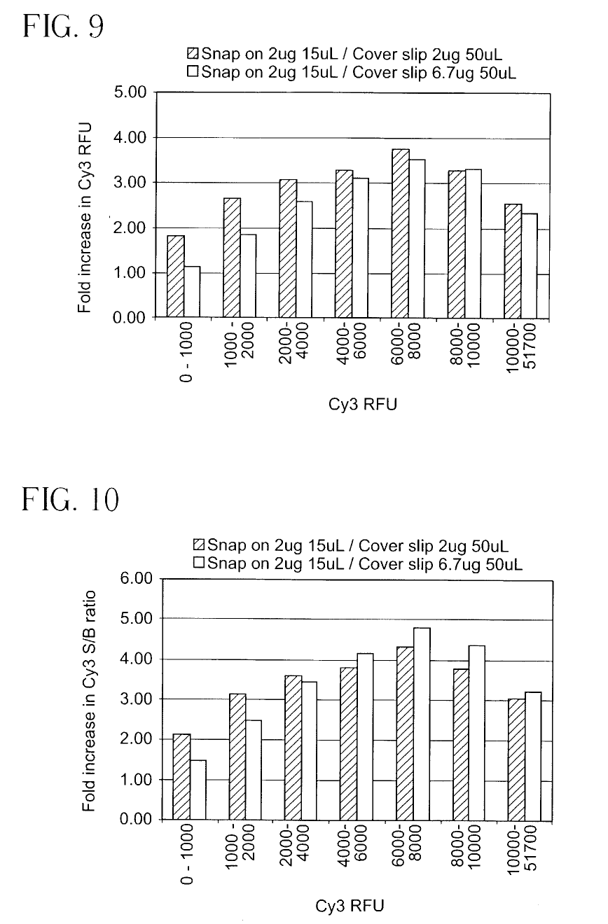

Comparative hybridization results of the tested 4K Cancer array are shown in FIGS. 7-10. FIGS. 7 and 8 respectively show the ratio of averaged net fluorescent signal for Cy 5 and the signal to background ratio (S/B) of the assay using a chamber similar to the one shown in FIG. 1 of the present invention compared to the conventional cover slip method. FIGS. 9 and 10 respectively show the ratio of averaged net fluorescent signal for Cy 3 and the signal to background ratio (S/B) of the assay using a chamber similar to the one shown in FIG. 1 of the present invention compared to the conventional cover slip method. FIG. 7 (Cy5) and the FIG. 9 (Cy3) show the increase in signal achieved by using the device according to one embodiment of the present invention. The shaded bars in the Figures represent the ratio of the signal obtained from a chamber according to one embodiment of the present invention with 2 μg of total RNA in 15 μL of solution to the signal obtained from a chamber formed using the cover slip method with 2 μg of total RNA in 50 μL of solution. The unshaded bars in the Figures represent the ratio of the signal obtained from a chamber according to one embodiment of the present invention with 2 μg of total RNA in 15 μL of solution to the signal obtained from a chamber formed using the cover slip method with 6.67 μg of total RNA in 50 μL of solution.

FIG. 8 (Cy5) and FIG. 10 (Cy3) show in the increase in signal to background using a chamber according to one embodiment of the present invention compared to the cover slip method. The x-axis represents the range of averaged net fluorescent signal performed with the present invention. A ratio of 1 signifies approximately equivalent performance in hybridization efficiency. As shown in FIGS. 7-10, the hybridization performed with the present invention (2 μg of total RNA in 15 μL) can achieve an increase in hybridization efficiency compared to the one that had the same total amount of total RNA (2 μg in 50 μL). In addition, increased hybridization efficiencies were observed in chambers of the present invention using only 2 μg of total RNA in 15 μL compared to chambers formed using the cover slip method that had the same concentration but more than 3 times the amount of total RNA (6.67 μg in 50 μL). This demonstrates that the present invention provides advantageous cost savings when running hybridization assays. Thus it is possible to obtain higher intensity signals by using less hybridization material and fluids using the chambers of the present invention.

It will be apparent to those skilled in the art that various modifications and variations can be made to the present invention without departing from the spirit or scope of the invention. Thus, it is intended that the present invention cover modifications and variations of this invention provided they come within the scope of the appended claims and their equivalents.

What is claimed is:

1. A biological or chemical reaction device comprising:
a generally planar base substrate having an inner surface including a specimen area;
a spacer element having a height on the base substrate defining a chamber surrounding the specimen area;
a generally planar cover substrate having a width and a length, an outer surface, and an inner surface opposing and substantially parallel to the inner surface of the base substrate; and
a flexible gripping element on the base substrate, the gripping element defining a spaced apart area adapted to receive the cover substrate and secure the cover substrate to the base substrate.

2. The device of claim 1, wherein the flexible gripping element forms a boundary around the spacer element, the gripping element defined by at least two substantially parallel, spaced apart walls including an upper portion and a lower portion adjacent the base substrate.

3. The device of claim 2, wherein the spacing between the substantially parallel walls is greater at the lower portion than the spacing between the walls at the top portion.

4. The device of claim 3, wherein the spacing between the parallel walls at the top portion is less than the width of the cover substrate.

5. The device of claim 2, wherein the walls are adapted to receive the cover substrate by snap fitting the cover substrate such that the inner surface of the cover substrate is in contact with the spacer element and the walls provide vertical holding force on the cover substrate.

6. The device of claim 2, wherein the flexible gripping element is defined by at least a pair of substantially parallel walls having an upper portion and a lower portion adjacent the base substrate, the walls including a sloped inner surface such that the wall has a thickness that is greater at the upper portion than the thickness at the lower portion.

7. The device of claim 2, further comprising a fluid inlet and a fluid outlet.

8. The device of claim 7, wherein the inlet and the outlet extend through the spacer element and flexible gripping element.

9. The device of claim 2, wherein the height of the spacer element is less than 100 microns.

10. The device of claim 9, wherein the height of the spacer element is less than 50 microns.

11. The device of claim 9, wherein the height of the spacer element is less than 10 microns.

12. The device of claim 1, further comprising a second spacer element on the outer surface of the cover substrate defining a second specimen area and a second flexible gripping element defining a pair of spaced apart walls adapted to receive a second cover substrate.

13. The device of claim 12, wherein the second cover substrate is adapted to snap fit between the spaced apart walls defined by the second flexible gripping element.

14. The device of claim 12, wherein at least one of the cover substrates includes a hole therein to allow fluid to flow therethrough.

15. The device of claim 14, wherein the device further includes microfluidic channels.

16. A biological or chemical reaction chamber comprising:
a base substrate including a pair of flexible, generally parallel, spaced apart walls having an upper portion and a lower portion and a cover substrate having a width adapted to be snap fit between the spaced apart walls.

17. The reaction chamber of claim 16, wherein the spacing between the walls adjacent the top portion is less than the spacing between the walls adjacent the bottom portion.

18. The reaction chamber of claim 17, wherein the width adjacent the top portion of the walls is less than the width of the cover substrate.

19. A method of manufacturing a biological or chemical reaction device comprising:
providing a generally planar base substrate having an inner surface including a specimen area;
forming a spacer element having a height on the base substrate defining a chamber surrounding the specimen area;
forming at least a pair of flexible, substantially parallel, spaced apart walls; and
snap fitting a generally planar cover substrate between the spaced apart walls, the cover substrate having a width and a length, an outer surface, and an inner surface opposing and substantially parallel to the inner surface of the base substrate.

20. The method of claim 19, wherein the spaced apart walls are formed by photolithography.

21. The method of claim 20, wherein the spaced apart walls are further formed by curing a monomer or polymer through a mask.

22. The method of claim 19, wherein the walls have an upper portion and a lower portion, and the thickness of the walls is greater adjacent the upper portion than the thickness of the walls adjacent the lower portion.

23. The method of claim 22, wherein the spacing between the upper portions of the walls is less than the width of the cover substrate.

24. The method of claim 19, wherein the spacer element is includes a polymer.

25. The method of claim 24, wherein the spacer is formed by spin coating.

26. The method of claim 19, further comprising providing a fluid inlet and a fluid outlet.

27. The method of claim 26, wherein the fluid inlet and fluid outlet extend through the spacer element and at least one of the spaced apart walls.
